(19) United States
(12) Patent Application Publication
(10) Pub. No.: US 2006/0174537 A1
(43) Pub. Date: Aug. 10, 2006

(54) Chumming device and associated system and method

(75) Inventors: Donald Van Woodham, Daphne, AL (US); Kevin R. Lyn, Raleigh, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: PSI Sales, Inc.

(21) Appl. No.: 11/327,285

(22) Filed: Jan. 6, 2006

Related U.S. Application Data
(60) Provisional application No. 60/641,680, filed on Jan. 6, 2005.

(51) Int. Cl. A01K 97/02; A01K 85/01

(52) U.S. Cl. 43/44.99; 43/42.06

(57) ABSTRACT

A chumming device is provided, comprising a container member defining an interior chamber adapted to contain a chum substance, and a dispersion mechanism operably engaged with the container member and configured cooperate with the container member to receive a flow of water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow via the dispersion mechanism in response only to the hydrodynamic force. Associated systems, devices, and methods are also provided.

### CROSS-REFERENCE TO RELATED APPLICATION

This application claims the benefit of U.S. Provisional Application No. 60/641,680, filed Jan. 6, 2005, which is incorporated herein in its entirety.

### BACKGROUND OF THE INVENTION

1. Field of the Invention

The present invention relates to chumming device for fish and, more particularly, to a device, system, and method for chumming for fish whereby a chum substance is released to, and in some instances at a depth under, the water in response to a hydrodynamic force generated by motion in relation to the water.

2. Description of Related Art

Fishermen sometimes troll baited hooks or lures in order to target certain fish. Often, the baited hooks or lures are attached to a fishing line extending from a rod and reel combination or outfit secured on a moving boat or vessel, such that the baited hook or lure skips or swims across a surface layer of the water behind the boat as the boat is moving. This technique is known as trolling. Trolling may also involve pulling hookless baits and/or lures in conjunction with the baited hooks and/or lures, wherein the hookless baits/lures are known as “teasers” used for attracting fish to the baited hooks and/or lures. In some instances, however, the fish targeted by the fisherman may be at a certain depth under the water surface, and the fisherman must get the baited hook under the surface of the water, as the boat is moving, in order to present the baited hook to the fish at that depth. This technique is known as controlled-depth fishing or controlled-depth trolling.

In order to fish by trolling at a controlled depth, a device referred to as a downrigger may be implemented or, in some instances, the baited hook or lure itself can be configured to dive to a certain depth in the water. The downrigger, when used for such a purpose, is mounted to the boat and has a length of cable or other line secured thereto and extending therefrom. At the end of the cable, opposite the downrigger, a depth-attaining element is attached. Such a depth-attaining element may comprise, for example, a lead ball, a weighted planer, or other appropriate device. The cable immediately above the depth-attaining element often carries a releasable clip, wherein the fishing line between the rod and reel outfit and the baited hook can be secured in the clip so as to travel with the clip as the depth-achieving element is lowered to the desired depth by the downrigger. In this manner, if a fish bites the baited hook, the clip will release the fishing line and the fisherman is free to fight the fish to the boat using the rod and reel outfit without interference from the cable and depth-attaining element.

Such controlled-depth fishing may also be accomplished in different manners. For example, the cable may be secured directly to the boat, for example to a stern cleat, eliminating the need for the downrigger device. In such instances, a releasable clip may be slidably attached to the cable and capable of gripping the fishing line. That is, the depth-attaining element, when deployed, tautly maintains the cable between the boat and the depth-attaining element. When the releasable clip is attached to the cable and fishing line, the force of the boat moving through the water provides a force on the baited hook and/or the clip that causes the clip to slide down the cable and under the water, at any distance along the cable up until the clip is stopped by the depth-attaining element. In other instances, for example, one or more trolling weights or a weighted planer may be attached to the fishing line between the baited hook and the rod and reel.

In any instance, while fishing by trolling, the fisherman may wish to chum the water in order to attract fish. Such chumming may be accomplished, for example, by cutting chunks of bait or grinding bait and dropping those bait portions into the water behind the boat, in hopes that the bait morsels will attract the fish to bite the baited hooks being trolled behind the boat. In some instances, certain bait may have an oil associated therewith after being ground or otherwise processed. Such fish oil or other oil can also be released from the boat, wherein the scent of the oil chum may disperse through the water and attract fish to bite the baited hooks being trolled behind the boat. However, such chumming is often accomplished at or about the water surface, and the bait portions or oil are generally not presented under the surface of the water until long after the trolling or moving boat has moved away from the position at which the chum is released into the water. In addition, since the boat is moving, the chum and the baited hooks/lures will generally coincide at the same position in the water for only a short time before the boat moves away. Both of these factors may also be additionally adversely affected by environmental factors such as wind, waves, and current. As such, any chum released into the water while trolling may not effectively serve to lure or attract fish to the baited hooks/lures pulled behind the boat.

Thus, there exists a need for a fish chumming device capable of releasing a chum substance into the water surface while the boat or vessel is moving through the water. Such a chumming device should desirably be capable or releasing the chum substance into the water in a controlled, selective, or otherwise restricted or limited manner, at a controlled-depth or on the surface of the water, such that the chum substance is released over an extended period of time and in efficient coincidence with the baited hook/lure or teaser. Such a chumming device should also be applicable to different methods of fishing with minimal or no modifications.

### BRIEF SUMMARY OF THE INVENTION

The above and other needs are met by the present invention which, in one embodiment, provides a chumming device, comprising a container member defining an interior chamber adapted to contain a chum substance, and a dispersion mechanism operably engaged with the container member and configured cooperate with the container member to receive a flow of water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow via the dispersion mechanism in response only to the hydrodynamic force.

Another aspect of the present invention comprises a controlled-depth chumming device adapted to be used with a vessel moving through water. Such a device includes a container member defining an interior chamber adapted to contain a chum substance and configured to be lowerable to a depth under a surface of the water as the vessel is moving. A dispersion mechanism is operably engaged with the container member and is configured to cooperate with the container member to receive a flow of the water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow under the water surface via the dispersion mechanism in response only to the hydrodynamic force.

Another aspect of the present invention comprises a controlled-depth chumming system adapted to be used with a vessel moving through water. Such a system includes a downrigger device operably engaged with the vessel and having a first end of a line attached thereto, wherein the line having an opposed second end capable of extending from the downrigger. A container member, defining an interior chamber adapted to contain a chum substance, is configured to be attached to the second end of the line so as to be lowerable to a depth under a surface of the water by the downrigger as the vessel is moving. A dispersion mechanism is operably engaged with the container member and is configured to cooperate with the container member to receive a flow of the water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow under the water surface via the dispersion mechanism in response only to the hydrodynamic force.

Yet another aspect of the present invention comprises a controlled-depth chumming system adapted to be used with a vessel moving through water. Such a system includes a line having a first end operably engaged with the vessel and an opposed second end extending therefrom. A depth-attaining device is attached to the second end of the line and is configured to reach a depth under a surface of the water as the vessel is moving such that the line tautly extends between the vessel and the depth-attaining device. A container member, defining an interior chamber adapted to contain a chum substance, is configured to be slidably engaged with the line so as to be lowerable along the line and under the water surface up to the depth of the depth-attaining device. A dispersion mechanism is operably engaged with the container member and is configured to cooperate with the container member to receive a flow of the water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow under the water surface via the dispersion mechanism in response only to the hydrodynamic force.

Still another aspect of the present invention comprises a controlled-depth chumming system adapted to be used with a vessel moving through water. Such a system includes a fishing device associated with the vessel and having a first end of a line attached thereto, wherein the line has an opposed second end capable of extending from the fishing device. An elongate leader member has opposed first and second ends, wherein the second end of the leader member has a hook device attached thereto and is adapted to interact with the water as the vessel is moving. A container member, defining an interior chamber adapted to contain a chum substance, is configured to be attached between the second end of the line and the first end of the leader member. The container member is further configured as a depth-attaining mechanism lowerable to a depth under a surface of the water by the fishing device, as the vessel is moving, such that the hook device attached to the second end of the leader member is also under the water surface. A dispersion mechanism is operably engaged with the container member and is configured to cooperate with the container member to receive a flow of the water thereby. The water flow provides an associated hydrodynamic force at least about the dispersion mechanism. The dispersion mechanism is further configured to cooperate with the container member such that the chum substance is extracted from the interior chamber of the container member and introduced directly into the water flow under the water surface in response only to the hydrodynamic force.

Another aspect of the present invention comprises a method of method of chumming, comprising receiving a flow of water about a dispersion mechanism operably engaged with a container member defining an interior chamber adapted to contain a chum substance. The water flow provides an associated hydrodynamic force at least about the dispersion mechanism, such that only the hydrodynamic force extracts the chum substance from the interior chamber of the container member via the dispersion mechanism and introduces the chum substance directly into the water flow.

Still another aspect of the present invention comprises a method of controlled-depth chumming from a vessel moving through water. First, a container member defining an interior chamber adapted to contain a chum substance is lowered to a depth under a surface of the water as the vessel is moving. A flow of the water is then received at least about a dispersion mechanism operably engaged with the container member. The water flow provides an associated hydrodynamic force about the dispersion mechanism, such that only the hydrodynamic force extracts the chum substance from the interior chamber of the container member via the dispersion mechanism and introduces the chum substance directly into the water flow under the water surface.

The container member can be lowered to the depth under the surface of the water with a downrigger device operably engaged with the vessel via a line extending therebetween. Alternatively, a depth-attaining device can be lowered to the depth under the surface of the water as the vessel is moving, wherein the depth-attaining device is operably engaged with the vessel via a line extending tautly therebetween, and the container member then made to slide along the line to a depth under the water surface up to the depth of the depth-attaining device. As a further alternative, the container member configured as a depth-attaining device can be lowered to the depth under the surface of the water as the vessel is moving, wherein the container member is operably engaged with a fishing device associated with the vessel via a line extending therebetween and also includes an elongate leader member attached thereto and extending away from the vessel to a hook device adapted to interact with the water as the vessel is moving, such that the hook device is also under the water surface.

Embodiments of the present invention thus provide significant advantages as disclosed herein.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1A and 1B are schematics illustrating controlled-depth fishing techniques utilizing a depth-attaining device serially disposed between a fishing device and a hook member according to one embodiment of the present invention;

FIGS. 2A, 2B, and 2C are schematics illustrating controlled-depth fishing techniques utilizing a depth-attaining device operably engaged with the vessel independently of the fishing device and the hook member according to an alternate embodiment of the present invention;

FIG. 3 is a schematic illustrating a controlled-depth fish chumming system, according to one embodiment of the present invention, implemented in a depth-attaining device;

FIG. 4 is a schematic illustrating a controlled-depth fish chumming system, according to an alternate embodiment of the present invention, implemented in a depth-attaining device;

FIG. 5 is a schematic illustrating an alternative embodiment of a chumming system according to the present invention embodied in a lure device having one or more hook members operably engaged therewith;

FIGS. 6A and 6B are schematics illustrating lure devices (teasers) having no hook members operably engaged therewith with which a chumming system according to the present invention may be implemented.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

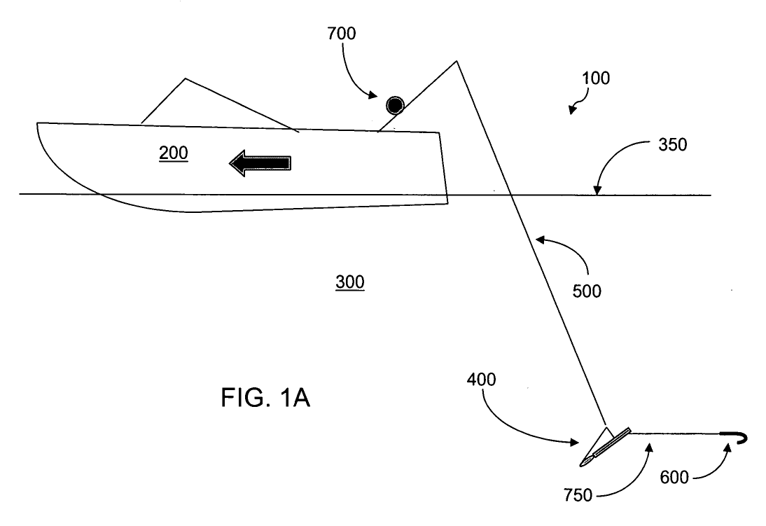

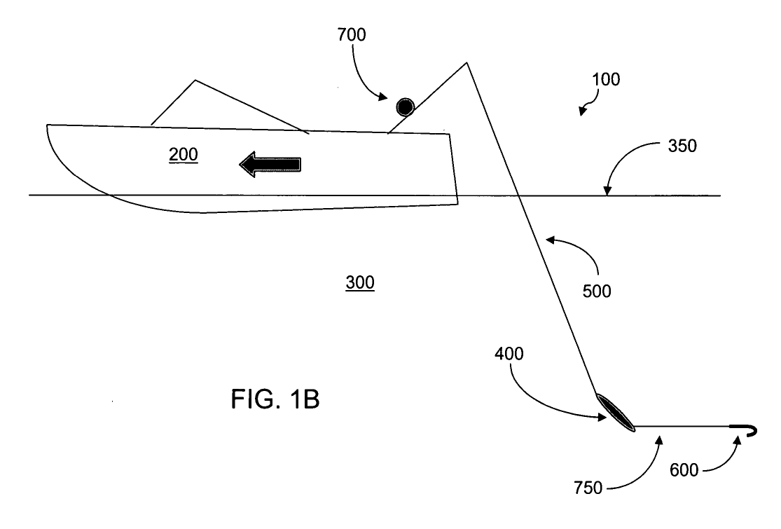

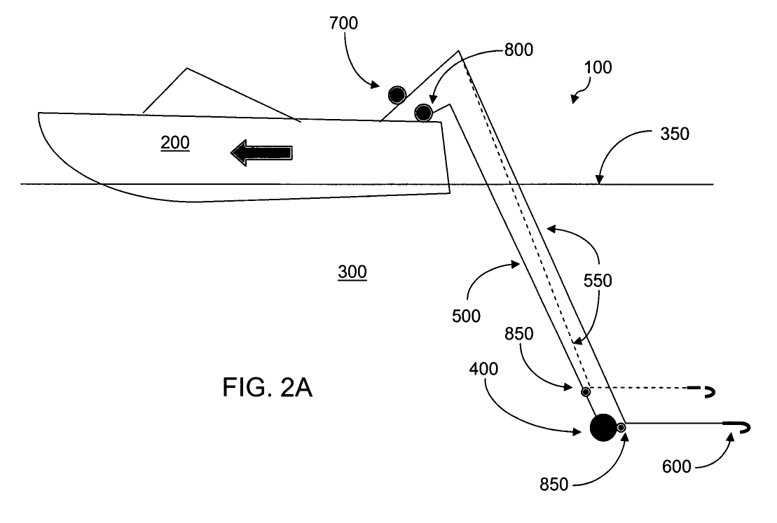

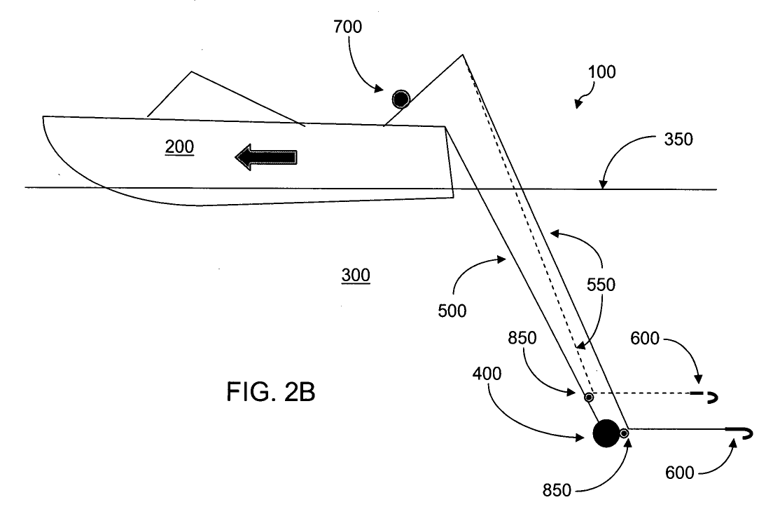

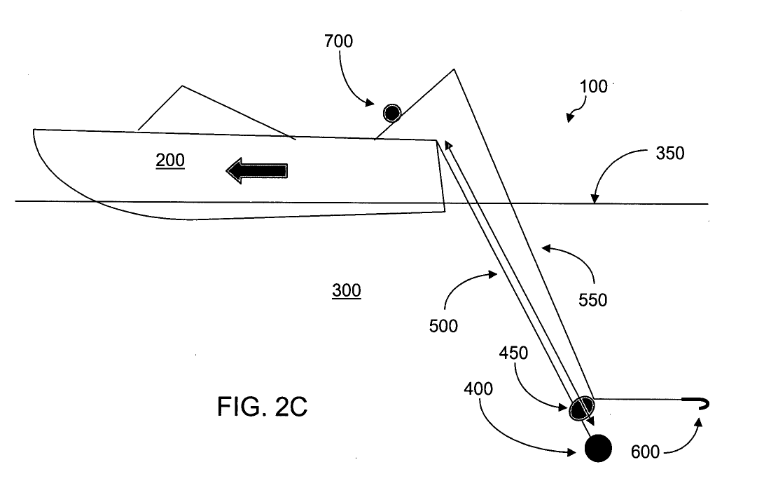

FIGS. 1A, 1B, 2A, 2B, and 2C illustrate various embodiments of a system for chumming for fish, the system being indicated generally by the numeral 100, wherein such a system 100 allows a fisherman trolling fishing baits to also chum for fish. In some instances, the system 100 is configured for controlled-depth chumming for fish, wherein such a system 100 allows a fisherman trolling fishing baits at a certain depth under the water surface to also chum for fish at a depth under the water surface, generally corresponding to the depth at which the bait is being trolled.

As previously discussed, fishing by trolling generally occurs in relation to a boat or other vessel 200 moving through a body of water 300. However, in some instances, wind, wave, and/or current action, for example, may cause the boat 200 to be stationary (i.e., no relative motion of the boat 200 with respect a course over ground), and the motion of the body of water 300 due to such factors as wind, wave, and current will still result in a flow of water past the boat 200 wherein, in such instances, fishing by trolling may still be possible. Accordingly, embodiments of the present invention consider such instances to be included within the scope of the disclosure presented herein. That is, it will be understood that any reference to the boat 200 moving through the water 300 will also include instances where the boat 200 is stationary, but has a flow of water thereby due to, for example, wind, wave, and/or current action, and thus may still allow the boat 200 to be trolling.

For controlled-depth fishing, a depth-attaining device 400, such as a weight (FIG. 1B), planer (FIG. 1A), downrigger ball, or other device, is tethered to the stern of the vessel 200 via a line member 500, wherein the line member 500 may be, for example, monofilament, braided filaments, or Dacron™ type fishing line, or single or multi-stranded metallic cable. The depth-attaining device 400 is configured to sink below the surface 350 of the water 300, when lowered from the vessel 200, to a depth under the water surface 350 determined by the length of the line member 500. Due to, for example, the drag force imparted on the depth-attaining device 400 and the line member 500 by the water 300 as the vessel 200 is moving (“blowback”), however, the depth-attaining device 400 is often diagonally-disposed behind the vessel 200 under the water surface 350 when trolling. In any instance, the line member 500 tethering the depth-attaining device 400 to the vessel 200 will remain taut, particularly when the vessel 200 is moving through the water 300.

In order to fish at this controlled depth, a hook member 600, which may or may not be associated with, for example, a lure device or bait (not shown), is operably engaged with the depth-attaining device 400 and/or the line member 500 such that the hook member 600 is pulled behind the trolling vessel 200 at or up to the depth under the water surface 350 of the depth-attaining device 400, as determined by the length of the line member 500. For example, in embodiments as shown in FIGS. 1A and 1B, the line member 500 may comprise a fishing line (which otherwise may be indicated as element 550 herein) attached at the vessel end thereof to a fishing device 700 such as, for example, a rod and reel outfit, associated with the vessel 200, and at the opposing end of the line member 500 to the depth-attaining device 400, wherein the nature of such a rod and reel outfit will be appreciated by one skilled in the art. An elongate leader member 750 may then be attached between the depth-attaining device 400 and the hook member 600. Once the depth-attaining device 400 is lowered by the fishing device 700 from the trolling vessel 200, the depth-attaining device 400 causes the leader member 750 and the hook member 600 to be pulled behind the vessel 200 at a depth under the water surface 350 determined by the depth reached by the depth-attaining device 400.

In another embodiment as shown in FIG. 2A, the line member 500 may be attached at the vessel end thereof to a downrigger device 800, wherein the downrigger device 800 is operably engaged with the vessel 200. Such a downrigger device 800 may comprise, for example, a reel mechanism (not shown) on which the line member 500 may be wound, wherein the reel mechanism may also be used to extend and retrieve the line member 500 with respect to the vessel 200. In such instances, the depth-attaining device 400 may be attached to the free end of the line member 500, (the end of the line member 500 not attached to the downrigger device 800) so as to be lowerable (and retrievable) by the downrigger device 800 to a selected depth under the water surface 350. In this configuration, a fishing device 700 such as, for example, a rod and reel outfit, may be separately (from the downrigger device 800) associated with the vessel 200, with a fishing line 550 extending therefrom. The hook member 600 may then be attached to the free end of the fishing line 550 (opposite the end attached to the fishing device 700). The fishing line 550, between the fishing device 700 and the hook member 600, may be removably attached to a clip 850 secured to the line member 500 at or near the depth-attaining device 400 (shown in phantom in FIGS. 2A and 2B) or to the depth-attaining device 400 itself. In this manner, the fishing line 550, and thus the hook member 600, can be lowered to the same depth under the water surface 350 as the depth-attaining device 400. Should a fish bite the hook member 600, the clip 850 is configured to release the fishing line 550 such that the fish can be fought and brought to the vessel 200, with the fishing device 700, independently of the line member 500 and the depth-attaining device 400. In a similar embodiment as shown in FIG. 2B, the downrigger device 800 may be eliminated and the line member 500 attached directly to the vessel 200, wherein lowering and retrieval of the line member 500 with respect to the vessel 200 is accomplished manually.

Thus, the depth-attaining device 400 may be attached directly to the vessel 200 via the line member 500 (FIG. 2B) or indirectly via the line member 500 and the downrigger device 800 (FIG. 2A). In either instance, the line member 500 will be taut when the depth-attaining device 400 is lowered below the water surface 350 and the vessel 200 is moving. In such embodiments, a supplemental depth-attaining device 450 may be removably and slidably attached to the line member 500, as shown in FIG. 2C. Such a supplemental depth-attaining device 450 may further be configured to have a fishing line 550 releasably secured thereto, the fishing line 550 extending from a fishing device 700, such as a rod and reel outfit, and having a hook member 600 attached to the free end thereof (opposite the end attached to the fishing device 700). As such, with the fishing line 550, between the fishing device 700 and the hook member 600, releasably secured to the supplemental depth-attaining device 450, the supplemental depth-attaining device 450 may be released to slide along the line member 500. In this manner, as the supplemental depth-attaining member 450 contacts the water 300 from the moving vessel 200, the force of the water 300 will cause the supplemental depth-attaining device 450 to slide down the line member 500 to any depth under the water surface 350 up to the depth of the depth-attaining member 400. The fishing line 550, and thus the hook member 600, can thereby be lowered to a depth under the water surface 350. Again, should a fish bite the hook member 600, the supplemental depth-attaining member 450 will release the fishing line 550 such that the fish can be fought and brought to the vessel 200, with the fishing device 700, independently of the line member 500 and the depth-attaining device 400. In such an embodiment, the supplemental depth-attaining device 450 separately connected to the vessel 200 via a tether (not shown), whereby the tether can be used to retrieve the supplemental depth-attaining device 450 to the vessel 200, independently of the line member 500 and the depth-attaining device 400. In other instances, the supplemental depth-attaining member 450 may be configured to be somewhat buoyant, even when filled with the chum substance 420, such that, when the vessel 200 is stopped or otherwise stationary, the buoyancy of the supplemental depth-attaining mechanism 450 cause the supplemental depth-attaining mechanism 450 to slide back up the line member 500 to the water surface 350 to facilitate retrieval from the vessel 200.

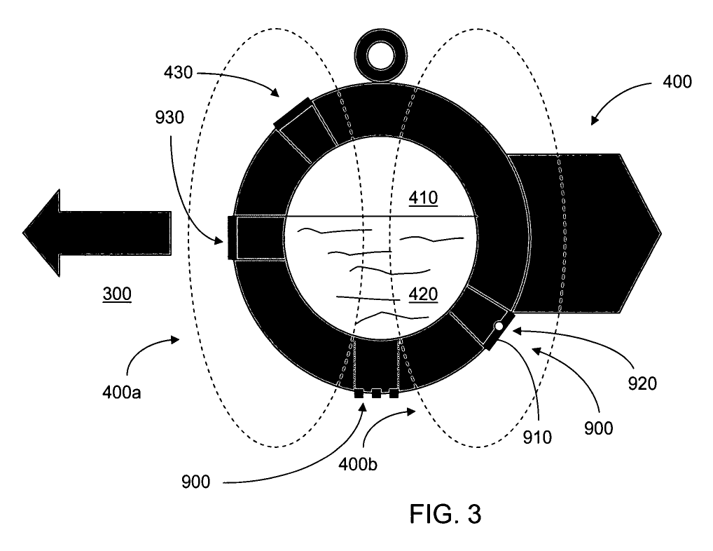

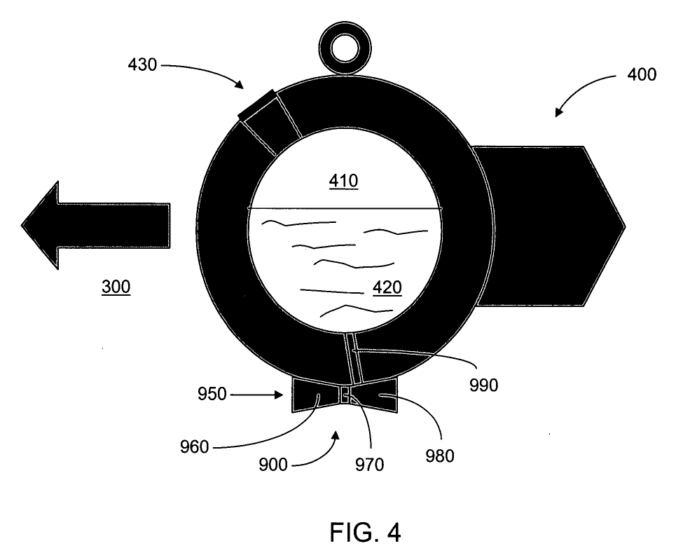

With the described embodiments heretofore, one purpose is to keep the hook member 600 at a depth below the water surface 350 as the vessel 200 is moving so as to fish by trolling. In such instances, it may be advantageous to the fishing party to also concurrently chum for fish at that depth so as to hopefully attract fish to the hook member 600. As such, the system 100 for controlled-depth chumming for fish may be configured to controllably release chum contained therein below the water surface 350 as the vessel 200 is moving (trolling). In such embodiments as shown in FIGS. 3 and 4, the system 100 may include an interior chamber 410 defined by a container member such as the depth-attaining device 400, 450 for receiving a chum substance 420 therein such as, for example, fish oil, through a sealable opening 430 in the depth-attaining device 400, 450. One purpose of such a system 100 is thus to release the chum substance 420 to the water 300 such that the chum substance 420 lures or attracts fish to the hook member 600. However, since the depth-attaining device 400, 450 and the chamber 410 defined thereby are generally of limited size, and since trolling is often a time-intensive fishing method (on the order of consecutive hours), it may be advantageous to limit or otherwise selectively release the chum substance 420 from the chamber 410 so as to avoid or minimize the need for frequent retrieval and redeployment of the depth-attaining device 400, 450 in order to refill the chamber 410.

According to embodiments of the present invention, the depth-attaining device 400, 450 is configured to controllably and/or selectively and/or limitedly release or meter the chum substance 420 from the chamber 410 into the water 300. In some particular instances, the chum substance 420 is released from the chamber 410 only in response to a force (hydrodynamic) generated by the water 300 moving thereby or thereabout. Such hydrodynamic force may be created by the vessel 200 moving through the water 300 or a water current acting on the vessel 200 and/or depth-attaining device 400, 450. In order to accomplish such a controlled release, the depth-attaining mechanism 400, 450 may have a dispersion mechanism 900 associated therewith and operably engaged with the chamber 410 holding the chum substance 420. The dispersion mechanism 900 may be configured, for example, to be responsive only to the hydrodynamic force thereabout to release the chum substance 420 only when the vessel 200/depth-attaining mechanism 400, 450 is moving through the water 300 or otherwise has a water current flowing thereby

For instance, as shown in FIG. 3, the dispersion mechanism 900 may comprise a flexible diaphragm 910 having at least one perforation 920, the at least one perforation 920 being sealed or substantially sealed at ambient pressure or above, either mechanically or due to the material characteristics of the diaphragm 910 itself. That is, once the chamber 410 is filled at ambient atmospheric pressure, the diaphragm 910 will not allow the chum substance 420 to pass from the chamber 410 through the at least one perforation 920. When lowered under the water surface 350, the positive underwater pressure will likewise not allow the chum substance 420 to pass from the chamber 410. However, the depth-attaining mechanism 400, 450 is further configured such that a pressure differential about the depth-attaining mechanism 400, 450 and/or the dispersion mechanism 900, caused by hydrodynamic force as the depth-attaining mechanism 400, 450 is moved through the water 300 by the vessel 200 (i.e. by trolling or by water current), causes deformation of the diaphragm 910 which, in turn, causes the at least one perforation 920 to dilate such that the chum substance 420 is able to pass through (or, in some instances, be forcibly extracted through) the at least one perforation 920. That is, the depth-attaining mechanism 400, 450 maybe configured, for example, to have a pressure differential thereabout when moved through the water 300, with one portion thereof experiencing a high hydrodynamic pressure 400a and another portion thereof experiencing a low hydrodynamic pressure 400b. As such, the dispersion mechanism 900 may be disposed along the low pressure area 400b such that the low pressure tends to suction or forcibly withdraw or extract the chum substance 420 from the chamber 410 through the at least one perforation 920 in the diaphragm 910 and, as a result, introduce the chum substance 420 directly into the water 300. One skilled in the art, however, will appreciate that the dispersion mechanism 900, as described, may take many different forms such as, for example, an appropriate valve mechanism, porous material, restricted capillary, or suitable controlled-release mechanism.

One skilled in the art will further appreciate that the dispersion mechanism 900 may take many different forms based upon the described pressure differential principle. For example, the depth-attaining mechanism 400, 450 may be additionally configured with a flexible secondary diaphragm 930 disposed about a high pressure portion 400a of the depth-attaining mechanism 400, 450. Such a secondary diaphragm 930 may be deformed inwardly with respect to the chamber 410, in response to being exposed to the hydrodynamic force of the moving water 300, such that the positive pressure created within the chamber 410 causes the chum substance 420 to be expelled from the chamber through the at least one perforation 920 in the diaphragm 910, which may not necessarily have to be disposed about a low pressure portion 400b of the depth-attaining mechanism 400, 450 (i.e. as shown in phantom in FIG. 3).

In another instance, as shown in FIG. 4, the dispersion mechanism 900 may be configured as a venturi 950 configure to have a tapering inlet 960 extending in a direction parallel to the water flow as the depth-attaining device 400, 450 is moved through the water 300. The tapering inlet 960 of the venturi 950 leads to a constriction 970 and then an expanding outlet 980. When water 300 flows through the venturi 950, a low pressure area, suction, or vacuum is created in the expanding outlet 980 following (downstream of) the constriction 970. As such, the venturi 950 may include a supply port 990 connecting the chamber 410 to the expanding outlet 980 for feeding the chum substance 420 into the water flow, wherein the supply port 990 may include an appropriate mechanism for limiting the release of the chum substance 420. Such a mechanism may comprise, for example, a perforated diaphragm as previously discussed, a valve mechanism, porous material, restricted capillary, or any other suitable controlled-release mechanism for metering the release of the chum substance 420 so as to avoid or minimize required refilling of the chamber 410 with additional chum substance 420 during a trolling period. One skilled in the art will also appreciate that the venturi 950 may be operably engaged with the depth-attaining device 400 about the periphery thereof, or may be defined by the depth-attaining device 400 itself, though many other venturi-type configurations may be possible. Such controlled release of the chum substance 420 may thus provide for chumming the water 300 in depthwise relation to the hook member 600 (more particularly, the chumming is performed at a depth below the water surface 350 corresponding to the depth under the water surface 350 at which the hook member 600 is being trolled from the moving vessel 200) as the vessel 200 is moving, but may conserve the remaining chum substance 420 in the chamber 410 when the vessel 200 is not moving through the water 300 (i.e. wherein fishing by trolling is not being performed from the vessel 200).

Many modifications and other embodiments of the inventions set forth herein will come to mind to one skilled in the art to which these inventions pertain having the benefit of the teachings presented in the foregoing descriptions and the associated drawings. For example, one skilled in the art will appreciate that a system 100 as described herein may otherwise have variations generally directed to any suitable or otherwise appropriate mechanism for controllably releasing a chum substance 420 under the water surface 350 in a metered manner using a dispersion mechanism 900 in communication with the chamber 410 containing the chum substance 420, wherein release of the chum substance 420 occurs in response to hydrodynamic force imparted to the system 100 by the depth-attaining mechanism 400, 450 being trolled through the water 300 by the vessel 200 at a controlled depth below the water surface 350.

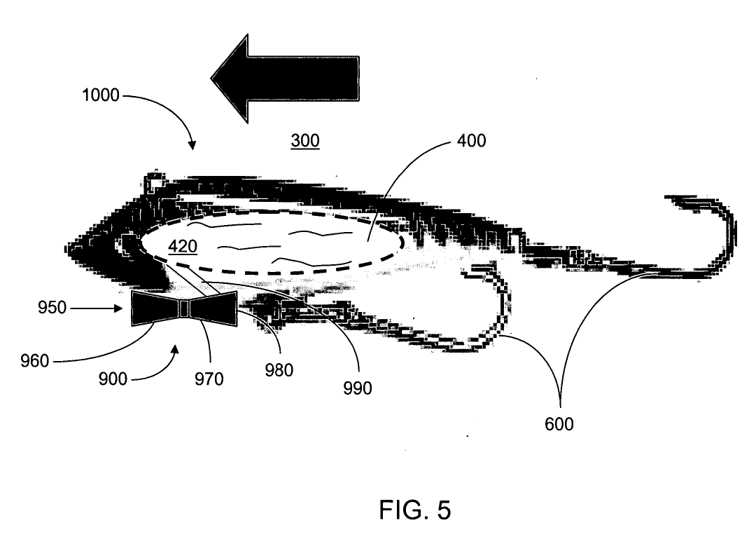

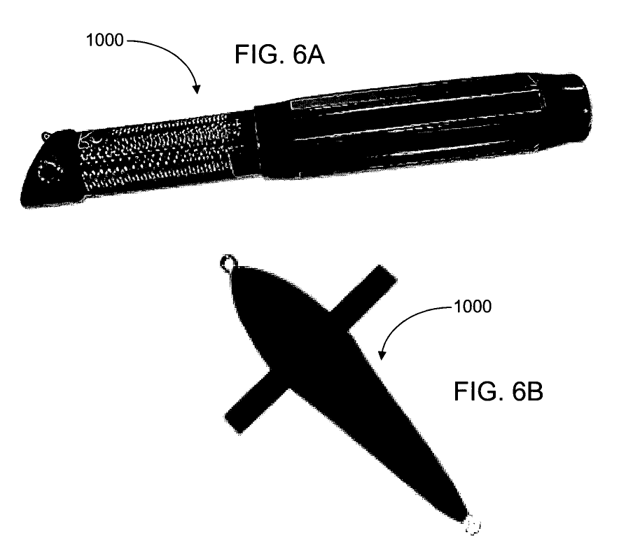

As a further example, one skilled in the art will also appreciate that a system 100 as described herein may otherwise have variations generally directed to any suitable or otherwise appropriate mechanism for controllably releasing a chum substance 420 at the water surface 350 in a metered manner using a dispersion mechanism 900 in communication with the chamber 410 containing the chum substance 420, wherein release of the chum substance 420 occurs in response to hydrodynamic force imparted to the system 100 being trolled by the vessel 200 at the water surface 350. That is, the system 100 may also be configured such that the container member/chamber 410 and the dispersion mechanism 900 are operably engaged with a lure device 1000, as shown in FIG. 5. The lure device 1000 may include one or more hook members 600 and may, in some instances, be configured to accept or receive natural bait, whether alive or dead, in portions or as a whole. In other embodiments, the lure device 1000 may be configured without hook members 600 wherein, in such instances, the lure device 1000 functions as a teaser device (see, e.g., FIGS. 6A and 6B) for luring a fish into a trolling spread such that the fish can then be directed to a separate hook member 600 attached to another lure device 1000 or to a “pitch bait” deployed from the vessel 200. One skilled in the art will further appreciate that such a lure device 1000 may be configured to vacillate so as to, for example, emulate a swimming fish, in response to being trolled through the water 300 or having a current flow of the water 300 thereby. In such instances, the lure device 1000, with or without the hook member(s) 600, may be configured as a depth-attaining device, such that the lure device 1000 runs under the water surface 350 while being trolled by the vessel 200. Alternatively, the lure device 1000, with or without the hook member(s) 600, may be configured to stay at or about the water surface 350 while being trolled by the vessel 200.

Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A chumming device, comprising:
a container member defining an interior chamber adapted to contain a chum substance; and
a dispersion mechanism operably engaged with the container member and configured cooperate with the container member to receive a flow of water thereby, the water flow providing an associated hydrodynamic force at least about the dispersion mechanism, the dispersion mechanism being further configured to cooperate with the container member such that the chum substance is extracted from the interior chamber of the container member and introduced directly into the water flow via the dispersion mechanism in response only to the hydrodynamic force.

2. A device according to claim 1 further comprising a hook device operably engaged with the container member.

3. A device according to claim 1 wherein the container member is configured to vacillate in response to the hydrodynamic force.

4. A device according to claim 1 wherein the dispersion mechanism comprises a diaphragm defining at least one perforation, the diaphragm being operably engaged with the container member so as to separate the interior chamber thereof from the water flow, the diaphragm being further configured to release the chum substance through the at least one perforation in response only to the hydrodynamic force.

5. A device according to claim 1 wherein the dispersion mechanism comprises a venturi extending parallel to the water flow and having a tapering inlet, an expanding outlet, and a supply port operably engaged between the interior chamber and the expending outlet, whereby the water flow through the expanding outlet of the venturi produces a hydrodynamic force for extracting the chum substance from the interior chamber and into the water flow via the supply port.

6. A device according to claim 1 wherein the dispersion mechanism is further configured to selectively limit extraction of the chum substance from the interior chamber such that the chum substance is selectively metered into the water flow.

7. A device according to claim 1 wherein the container member and the dispersion mechanism are operably engaged with at least one of a fishing lure element having a hook device, and a fishing lure element without a hook device.

8. A controlled-depth chumming device adapted to be used with a vessel moving through water, said device comprising:
a container member defining an interior chamber adapted to contain a chum substance and configured to be lowerable to a depth under a surface of the water as the vessel is moving; and
a dispersion mechanism operably engaged with the container member and configured to cooperate with the container member to receive a flow of the water thereby, the water flow providing an associated hydrodynamic force at least about the dispersion mechanism, the dispersion mechanism being further configured to cooperate with the container member such that the chum substance is extracted from the interior chamber of the container member and introduced directly into the water flow under the water surface via the dispersion mechanism in response only to the hydrodynamic force.

9. A device according to claim 8 further comprising a hook device operably engaged with the container member.

10. A device according to claim 8 wherein the dispersion mechanism comprises a diaphragm defining at least one perforation, the diaphragm being operably engaged with the container member so as to separate the interior chamber thereof from the water flow, the diaphragm being further configured to release the chum substance through the at least one perforation in response only to the hydrodynamic force.

11. A device according to claim 8 wherein the dispersion mechanism comprises a venturi extending parallel to the water flow and having a tapering inlet, an expanding outlet, and a supply port operably engaged between the interior chamber and the expending outlet, whereby the water flow through the expanding outlet of the venturi produces a hydrodynamic force for extracting the chum substance from the interior chamber and into the water flow via the supply port.

12. A device according to claim 8 wherein the dispersion mechanism is further configured to selectively limit extraction of the chum substance from the interior chamber such that the chum substance is selectively metered into the water flow.

13. A device according to claim 8 wherein the container member and the dispersion mechanism are operably engaged with at least one of a fishing lure element having a hook device, and a fishing lure element without a hook device.

14. A controlled-depth chumming system adapted to be used with a vessel moving through water, said system comprising:
a downrigger device operably engaged with the vessel and having a first end of a line attached thereto, the line having an opposed second end capable of extending from the downrigger;
a container member defining an interior chamber adapted to contain a chum substance and configured to be attached to the second end of the line so as to be lowerable to a depth under a surface of the water by the downrigger as the vessel is moving; and
a dispersion mechanism operably engaged with the container member and configured to cooperate with the container member to receive a flow of the water thereby, the water flow providing an associated hydrodynamic force at least about the dispersion mechanism, the dispersion mechanism being further configured to cooperate with the container member such that the chum substance is extracted from the interior chamber of the container member and introduced directly into the water flow under the water surface via the dispersion mechanism in response only to the hydrodynamic force.

15. A system according to claim 14 further comprising a hook device operably engaged with the container member.

16. A system according to claim 14 wherein the dispersion mechanism comprises a diaphragm defining at least one perforation, the diaphragm being operably engaged with the container member so as to separate the interior chamber thereof from the water flow, the diaphragm being further configured to release the chum substance through the at least one perforation in response only to the hydrodynamic force.

17. A system according to claim 14 wherein the dispersion mechanism comprises a venturi extending parallel to the water flow and having a tapering inlet, an expanding outlet, and a supply port operably engaged between the interior chamber and the expending outlet, whereby the water flow through the expanding outlet of the venturi produces a hydrodynamic force for extracting the chum substance from the interior chamber and into the water flow via the supply port.

18. A system according to claim 14 wherein the dispersion mechanism is further configured to selectively limit extraction of the chum substance from the interior chamber such that the chum substance is selectively metered into the water flow.

19. A controlled-depth chumming system adapted to be used with a vessel moving through water, said system comprising:
a line having a first end operably engaged with the vessel and an opposed second end extending therefrom;
a depth-attaining device attached to the second end of the line and being configured to reach a depth under a surface of the water as the vessel is moving such that the line tautly extends between the vessel and the depth-attaining device;
a container member defining an interior chamber adapted to contain a chum substance and configured to be slidably engaged with the line so as to be lowerable along the line and under the water surface up to the depth of the depth-attaining device; and
a dispersion mechanism operably engaged with the container member and configured to cooperate with the container member to receive a flow of the water thereby, the water flow providing an associated hydrodynamic force at least about the dispersion mechanism, the dispersion mechanism being further configured to cooperate with the container member such that the chum substance is extracted from the interior chamber of the container member and introduced directly into the water flow under the water surface via the dispersion mechanism in response only to the hydrodynamic force.

20. A system according to claim 19 further comprising a hook device operably engaged with the container member.

21. A system according to claim 19 wherein at least one of the container member and the dispersion mechanism are operably engaged with a fishing line extending therefrom to the vessel.

22. A system according to claim 21 wherein the container member and the dispersion mechanism are configured to be releasable from the line so as to be operably engaged with the vessel only via the fishing line.

23. A system according to claim 19 wherein the dispersion mechanism comprises a diaphragm defining at least one perforation, the diaphragm being operably engaged with the container member so as to separate the interior chamber thereof from the water flow, the diaphragm being further configured to release the chum substance through the at least one perforation in response only to the hydrodynamic force.

24. A system according to claim 19 wherein the dispersion mechanism comprises a venturi extending parallel to the water flow and having a tapering inlet, an expanding outlet, and a supply port operably engaged between the interior chamber and the expending outlet, whereby the water flow through the expanding outlet of the venturi produces a hydrodynamic force for extracting the chum substance from the interior chamber and into the water flow via the supply port.

25. A system according to claim 19 wherein the dispersion mechanism is further configured to selectively limit extraction of the chum substance from the interior chamber such that the chum substance is selectively metered into the water flow.

26. A system according to claim 19 wherein the container member and the dispersion mechanism are operably engaged with at least one of a fishing lure element having a hook device, and a fishing lure element without a hook device.

27. A controlled-depth chumming system adapted to be used with a vessel moving through water, said system comprising:
a fishing device associated with the vessel and having a first end of a line attached thereto, the line having an opposed second end capable of extending from the fishing device;
an elongate leader member having opposed first and second ends, the second end of the leader member having a hook device attached thereto and adapted to interact with the water as the vessel is moving;
a container member defining an interior chamber adapted to contain a chum substance and configured to be attached between the second end of the line and the first end of the leader member, the container member being further configured as a depth-attaining mechanism lowerable to a depth under a surface of the water by the fishing device, as the vessel is moving, such that the hook device attached to the second end of the leader member is also under the water surface; and
a dispersion mechanism operably engaged with the container member and configured to cooperate with the container member to receive a flow of the water thereby, the water flow providing an associated hydrodynamic force at least about the dispersion mechanism, the dispersion mechanism being further configured to cooperate with the container member such that the chum substance is extracted from the interior chamber of the container member and introduced directly into the water flow under the water surface in response only to the hydrodynamic force.

28. A system according to claim 27 wherein the dispersion mechanism comprises a diaphragm defining at least one perforation, the diaphragm being operably engaged with the container member so as to separate the interior chamber thereof from the water flow, the diaphragm being further configured to release the chum substance through the at least one perforation in response only to the hydrodynamic force.

29. A system according to claim 27 wherein the dispersion mechanism comprises a venturi extending parallel to the water flow and having a tapering inlet, an expanding outlet, and a supply port operably engaged between the interior chamber and the expending outlet, whereby the water flow through the expanding outlet of the venturi produces a hydrodynamic force for extracting the chum substance from the interior chamber and into the water flow via the supply port.

30. A system according to claim 27 wherein the dispersion mechanism is further configured to selectively limit extraction of the chum substance from the interior chamber such that the chum substance is selectively metered into the water flow.

31. A method of chumming, comprising:
receiving a flow of water about a dispersion mechanism operably engaged with a container member defining an interior chamber adapted to contain a chum substance, the water flow providing an associated hydrodynamic force at least about the dispersion mechanism, such that only the hydrodynamic force extracts the chum substance from the interior chamber of the container member via the dispersion mechanism and introduces the chum substance directly into the water flow.

32. A method according to claim 31 wherein the dispersion mechanism comprises a diaphragm defining at least one perforation, the diaphragm being operably engaged with the container member so as to separate the interior chamber thereof from the water flow, and receiving a flow of water further comprises receiving a flow of water about the dispersion mechanism such that the hydrodynamic force dilates the at least one perforation and causes the chum substance to be released therethrough directly into the water flow.

33. A method according to claim 31 wherein the dispersion mechanism comprises a venturi extending parallel to the water flow and having a tapering inlet, an expanding outlet, and a supply port operably engaged between the interior chamber and the expending outlet, and receiving a flow of water further comprises receiving a flow of water through the venturi such that the hydrodynamic force produces a suction through the expanding outlet and causes the chum substance to be extracted from the interior chamber and directly into the water flow via the supply port.

34. A method according to claim 31 further comprising selectively limiting extraction of the chum substance from the interior chamber with the dispersion mechanism such that the chum substance is selectively metered into the water flow.

35. A method of controlled-depth chumming from a vessel moving through water, said method comprising:
lowering a container member defining an interior chamber adapted to contain a chum substance to a depth under a surface of the water as the vessel is moving; and
receiving a flow of the water at least about a dispersion mechanism operably engaged with the container member, the water flow providing an associated hydrodynamic force about the dispersion mechanism, such that only the hydrodynamic force extracts the chum substance from the interior chamber of the container member via the dispersion mechanism and introduces the chum substance directly into the water flow under the water surface.

36. A method according to claim 35 wherein the dispersion mechanism comprises a diaphragm defining at least one perforation, the diaphragm being operably engaged with the container member so as to separate the interior chamber thereof from the water flow, and receiving a flow of water further comprises receiving a flow of water about the dispersion mechanism such that the hydrodynamic force dilates the at least one perforation and causes the chum substance to be released therethrough directly into the water flow.

37. A method according to claim 35 wherein the dispersion mechanism comprises a venturi extending parallel to the water flow and having a tapering inlet, an expanding outlet, and a supply port operably engaged between the interior chamber and the expending outlet, and receiving a flow of water further comprises receiving a flow of water through the venturi such that the hydrodynamic force produces a suction through the expanding outlet and causes the chum substance to be extracted from the interior chamber and directly into the water flow via the supply port.

38. A method according to claim 35 further comprising selectively limiting extraction of the chum substance from the interior chamber with the dispersion mechanism such that the chum substance is selectively metered into the water flow.

39. A method according to claim 35 wherein lowering a container member further comprises lowering a container member to a depth under a surface of the water with a downrigger device operably engaged with the vessel via a line extending therebetween.

40. A method according to claim 35 wherein lowering a container member further comprises:
lowering a depth-attaining device to the depth under the surface of the water as the vessel is moving, the depth-attaining device being operably engaged with the vessel via a line extending tautly therebetween; and
sliding the container member along the line to a depth under the water surface up to the depth of the depth-attaining device.

41. A method according to claim 35 wherein lowering a container member further comprises lowering a container member configured as a depth-attaining mechanism to the depth under the surface of the water, the container member being operably engaged with a fishing device associated with the vessel via a line extending therebetween and including an elongate leader member attached thereto and extending away from the vessel to a hook device adapted to interact with the water, such that the hook device is also under the water surface as the vessel is moving.
